(19) United States
(12) Patent Application Publication
(10) Pub. No.: US 2009/0084845 A1
(43) Pub. Date: Apr. 2, 2009

(54) Method and System for Automated Sorting of Randomly Supplied Packs of Lottery Game Tickets

(75) Inventor: Keith Post, Cumming, GA (US)

Correspondence Address: DORITY & MANNING, P.A., POST OFFICE BOX 1449, GREENVILLE, SC, 29602-1449, US

(73) Assignee: SCIENTIFIC GAMES INTERNATIONAL, INC., NEWARK, DE (US)

(21) Appl. No.: 12/235,735

(22) Filed: Sep. 23, 2008

Related U.S. Application Data
(60) Provisional application No. 60/975,946, filed on Sep. 28, 2007.

(51) Int. Cl. G06F 19/00

(52) U.S. Cl. 235/385; 221/7

(57) ABSTRACT

An automated method and system for sorting packs of lottery tickets supplied in a random order includes designating collections of the ticket packs, and assigning each particular collection to a bin position along an automated sorting line. Each ticket pack is identified with a particular collection as a function of data marks on the ticket packs. The ticket packs are conveyed in a random linear sequence past a data mark reader and to the bin positions. For each scanned pack, a bin position is determined for a collection the respective ticket pack is needed for. The ticket packs are automatically removed at the proper bin position.

### PRIORITY CLAIM

The present application claims priority to U.S. Provisional Application Ser. No. 60/975,946, filed Sep. 28, 2007.

### FIELD OF THE INVENTION

The present invention relates to an automated system and associated methodology for sorting packs of lottery tickets supplied in a random sequence.

### BACKGROUND OF THE INVENTION

Various examples of lottery games are well-known wherein players purchase game related tickets at a remote point of sale, such as a retail establishment. The tickets may be, for example, Instant Scratch-Off tickets related to any number of Instant Scratch-Off games, or may be tickets related to a subsequent game or drawing. The tickets (also referred to as game cards herein) are typically supplied to the retailer at the point of sale in roll or fan-folded block form. Each ticket typically has a serial number or other identifying mark, and accountability of the tickets (and associated packs or rolls) is strictly maintained by the game administrator or state authority to ensure integrity of the game. In this regard, it is imperative that the retailer receives the correct number, type, and assigned lottery tickets for the particular games that the retailer is authorized to conduct. Retailers generally are authorized to conduct numerous games, and thus require a periodic supply or numerous different lottery tickets.

At the ticket manufacturing facilities, each type of game ticket is produced in a processing line whereby a vast number of the tickets are printed in a single processing batch, and may be both customer and game specific. At the end of this process, the tickets are packaged and sealed in rolls or “bricks” (referred to collectively herein as “packs”) with the serial numbers of the individual tickets within each pack being recorded by a central control system computer. The packs may be stored to fill future orders, or may be designated for particular orders at the time of manufacturer, as noted and recorded by the control system. For example, a pack may be packaged and sealed with a label, insert card, or other data mark (i.e., a bar code) indicating that the pack is for a particular order number, retailer, and so forth. The packs are boxed, and palletized, and may be shipped to the specific customer's warehouse for storage and shipment to the retailer.

As mentioned, retailers typically require multiple types of game tickets on a regular periodic basis and, thus, the warehouse facility is required to accumulate and store the different packs of tickets. To subsequently fill orders, personnel typically hand select the necessary packs from the various different supplies/storage locations for the correct packs for each order. This manual process is tedious, slow, and is prone to human error.

The present invention relates to an automated system and method for sorting randomly supplied packs of lottery tickets that offer significant benefits over past practices.

### SUMMARY OF THE INVENTION

Objects and advantages of the invention will be set forth in part in the following description, or may be obvious from the description, or may be learned through practice of the invention.

In accordance with certain aspects of the invention, an automated method is provided for sorting packs of lottery tickets that are supplied in a random sequential order. It should be appreciated that the terms “lottery ticket” or “ticket” are meant to encompass any type of game cards that are supplied to point of sale establishments in a collective pack, such as rolls, fan-folded bricks, and the like.

Each pack of tickets has a data mark applied thereto. This data mark may be, for example, a barcode, label, or any other information conveying mark. The data mark may be a mark that is applied to a single ticket within the pack. The data mark conveys certain information relevant to the pack of tickets, as discussed in greater detail herein.

In the automated method, a plurality of the ticket packs are designated as belonging to collective group. This group may correspond, for example, to a full or partial shipment for a particular customer order. It should be appreciated that a “collection” or “collective group” may be any designation of one or more packs of tickets for any reason. In a particular embodiment, each collection corresponds to a shipment of tickets designated for a point of sale. For example, each collection may be part of an order of a plurality of different type of lottery game tickets intended for sale at a particular retail establishment. The data mark enables identification of the respective ticket packs as belonging to one or more of the designated collections. Each particular collection is assigned to a respective bin position along an automated sorting line. The ticket packs are conveyed along this line in a random linear sequence past the bin positions.

At an initial position of the conveying line, the data mark of the ticket pack is scanned or read, for example by an optical scanner or similar device. Based on the information conveyed by the data mark, a control system determines which bin the respective ticket pack should be deposited at. In other words, the system determines that the particular ticket pack is needed to complete a collection at a particular bin position, and designates the ticket pack for delivery to and that respective bin position. Once the ticket pack reaches the bin position, it is automatically removed from the conveying line and placed/dropped into a bind or other receptacle.

Upon satisfying or completing the collection requirements at any individual bin position, the completed collection is removed from the bin position for further processing. For example, the collection may be a full or partial shipment related to a particular customer order, and the collection may be forwarded to a packaging/shipping station where it is verified and shipped to the retailer.

It should be appreciated that the collection may be “removed” from the individual bin position by a manual or automated process. In a particular embodiment, the bin positions each contain an individual receptacle or bin that is manually placed onto a separate conveyor that transports the bins to a further processing station, such as the packaging/shipping station. It should, however, be appreciated that an automated transport system is also applicable and within the scope and spirit of the invention.

At any individual bin position wherein a collection has been completed and removed from the position, the control system assigns a new collection requirement to the respective bin position, wherein the process continues.

In a particular embodiment, the control system includes a queue of various required collections (i.e. shipments to be filled) and the next collection in the queue is simply assigned to the next available bin position. Because the ticket packs are initially supplied in a random order, the next available bin position cannot be readily determined at any given time. However, this is of no consequence to the method and system according to the invention.

In broad aspects, the data marks on each of the ticket packs may identify any characteristic of the lottery tickets in the pack that is compared to requirements of the collection assigned to the respective bin position along which the ticket pack is conveyed. For example, the collection may call for a given number of ticket packs relating to a particular type of game, such as an instant bingo scratch-off game. The data marks on each of the ticket packs may simply identify the type of game the tickets relate to. In this case, the individual serial number on any one of the tickets, such as the uppermost ticket, may be scanned by a reader at the scanning station for identification of the type of lottery game.

It should be readily appreciated that the data marks associated with each of the individual ticket packs may relate to any manner of information useful for forming collective groups of the tickets for any reason.

It may be desired to note or record the identification of each ticket pack that is removed at any given bin position. This information may prove useful in a subsequent verification stage wherein the ticket packs that are associated with an individual collection are verified prior to, for example, packaging and shipping the collection.

In a particular embodiment, once the collection is removed from a bin position, it is transported for packaging and shipping. At the packaging/shipping station, it may be desired to conduct a final verification of the order. For this reason, the station may include any manner of terminal, printer, read out, or other interface with the control system for conveying and receipt of information related to the individual packs. In one set up, the station may include a scanner wherein any one of the packs within the collection is scanned. This action triggers the control system to transmit data related to the collection to which that particular pack of tickets belongs. For example, the scanned pack may have a data mark indicating a particular shipment number. The control system would send to the station information related to the shipment and the packs that were removed from the processing line to fill the shipment. Personnel or automated systems at the station may then use this information to conduct a final verification of the integrity and completeness of the order prior to sealing the packs within a shipping package.

In a unique embodiment, the ticket packs are conveyed at individual positions defined on a linear conveyor past the respective bin positions. These individual positions contain any manner of automated mechanism that is automatically actuated to move the ticket packs off of the conveyor and into a bin at the respective bin position. For example, the actuator may include any configuration of mechanical, pneumatic, hydraulic, or other system to push, move, or otherwise transport the ticket packs from the conveyor onto or into a receptacle. It should be appreciated that “receptacle” and “bin” are used herein to encompass any manner of device or system that receives the ticket packs, including a conveyor, chute, or the like.

In a particular embodiment, the individual positions on the linear conveyor are defined by adjacently disposed trays that automatically pivot or tilt at the proper bin position to cause the ticket packs to slide off of the tray and into a bin or receptacle. In a particular useful embodiment, bin positions are defined along each longitudinal side of the conveyor, and the trays are configured to tilt in either transverse direction relative to the conveyor. In this embodiment, the effective length of the system is significantly reduced, while increasing the capacity of the system.

Each of the bin positions may include a visible indication of the total required number of ticket packs needed to complete the collection or order assigned to each respective bin position. This visible indication may be, for example, a display panel or screen that indicates the initial number of ticket packs required by the assigned collection. Each time a ticket pack is removed at the bin position to satisfy one of the requirements, the display is decremented. In this manner, the displays give a continuous current indication of the fill status at any individual bin. For example, if the display status indicates a “2”, then personnel monitoring the process know that two more ticket packs are necessary to complete the order or collection assigned at that particular bin position. Once the display indicates “0”, then the personnel know that the collection has been completed and that no further ticket packs will be automatically removed from the conveying line for that particular bin position. The bin may then be removed for further processing. After a completed collection is removed from a respective bin position, an empty or receptacle may replace the full bin, and the personnel may reset the bin position, for example by simply pressing a reset button or otherwise conveying to the control system that the bin position is now ready to accept a new assigned collection. The control system assigns this new collection, and the bin position functions as before in filling or completing a new collection.

The invention also encompasses various embodiments of automated systems for sorting packs of lottery tickets supplied in a random order according to the methodology discussed above. For example, this automated system may include a ticket pack conveyor having a plurality of individual positions defined therealong for receipt of individual ticket packs at each conveyor position. A plurality of bin positions may be defined alongside at least one longitudinal side of the conveyor, and desirably along both sides of the conveyor. A reader is operatively associated with each of the bin positions to read the data marks on each ticket pack conveyed past the respective bin positions. In this regard, an individual reader may be provided at each bin position, or bin positions may share one or more readers. Means for automatically removing a ticket pack from the conveyor positions and into a bin at the bin positions is also provided. This means may include any manner of mechanical, pneumatic, hydraulic, or other suitable configuration for moving the ticket packs off of the conveyor. As discussed above, this means may include trays that tilt in either transverse direction. In an alternate embodiment, the means may include a pushing bar that moves across the conveyor to push the packs off of the conveyor. In still an alternative embodiment, air jets may be actuated to push the ticket packs off of the conveyor. It should be appreciated by those skilled in the art that any manner of system may be utilized in this regard.

The system preferably includes a control system that is in communication with the readers and automatic removing means. The control system assigns a collection of ticket packs, such as an order of ticket packs, to each of the bin positions and automatically actuates the removing means upon the reader at a respective bin position indicating that a ticket pack being conveyed therepast belongs to the collection or order assigned to that bin position.

A control panel may be associated with each of the bin positions, with this control panel including a display that indicates the number of ticket packs required to complete a collection assigned to the respective bin position, as discussed above. This control panel may also include a button or other actuating mechanism that allows personnel to reset the bin position for acceptance of a new collection or order of ticket packs.

Aspects of the invention will be described in greater detail below by reference to particular embodiments illustrated in the figures.

### BRIEF DESCRIPTION OF THE DRAWINGS

FIG. 1 is a diagrammatic layout of a system incorporating aspects of the invention.

FIG. 2 is a partial side view of a portion of the system in FIG. 1.

FIG. 3 is a partial transverse view of an individual bin position according to an embodiment of the invention.

FIG. 4 is a basic block diagram illustrating control aspects of the invention.

FIG. 5 is a flow chart diagram illustrating a particular embodiment of a methodology according to the invention.

### DETAILED DESCRIPTION

Reference will now be made in detail to embodiments of the method and system according to the invention, particular examples of which are illustrated in the drawings. Each embodiment is provided by way of explanation of the invention, and not meant as a limitation of the invention. For example, features illustrated or described with respect to one embodiment may be used with another embodiment to yield still a further embodiment. It is intended that the invention include these and other modifications and variations to the embodiments illustrated and described herein as come within the scope and spirit of the invention.

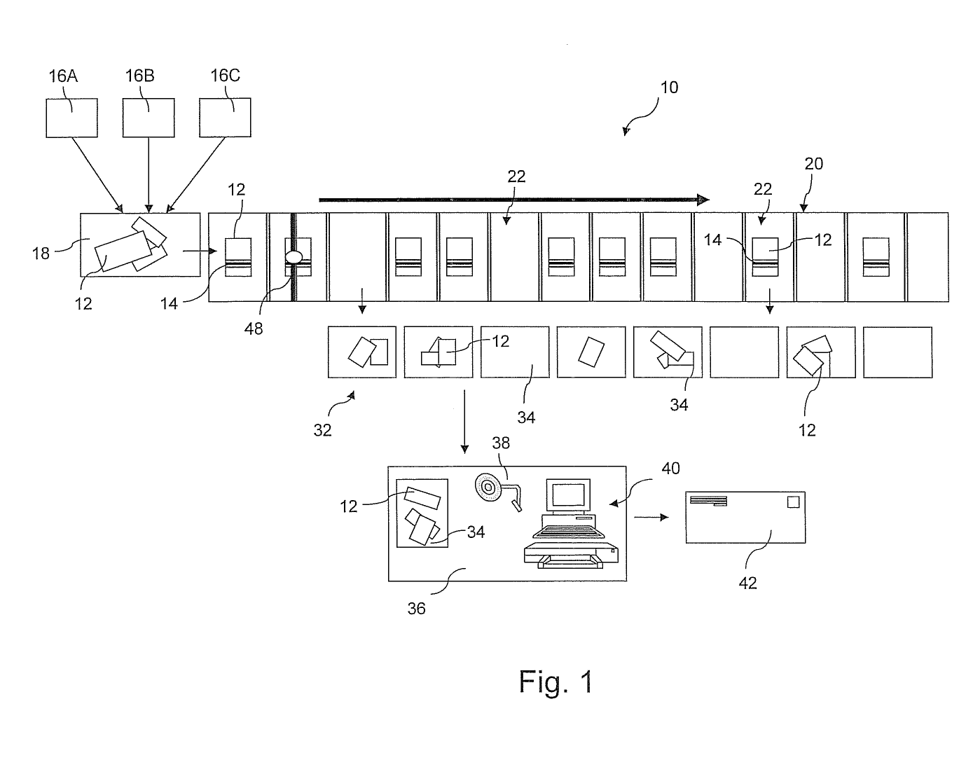

In FIG. 1, an embodiment of a system 10 in accordance with aspects of the invention is illustrated. Packs of lottery tickets 12 are initially supplied to a load station 18 from various sources 16a, 16b, 16c. These sources may be, for example, processing lines wherein the tickets are processed, storage bins, conveyors, and so forth. Each individual source 16a, 16b, 16c may supply the same type of lottery ticket packs 12, or different types of packs depending on the nature of the source. At the load station 18, the various packs 12 are randomly deposited for subsequent placement onto a linear conveyor 20.

Each of the ticket packs 12 includes a data mark 14 that identifies a particular characteristic of the ticket pack. This data mark 14 may be any manner of device or mark capable of conveying information to a reader or scanner. For example, in a particular embodiment, the data mark 14 may comprise an insert card that is placed within the ticket pack 12 prior to sealing of the pack. The insert card may contain the data in printed form, electronic form, or stored in any other medium that is readily scanned or interpreted. In an alternative embodiment, the data mark 14 may be a label or similar device applied to the wrapping material of the individual ticket packs 12. In still another embodiment, the data mark 14 may comprise a bar code or other symbol applied to each individual ticket within the pack 12, with at least one of these bar codes or symbols being visible through the packaging material of the pack for subsequent reading. In yet another embodiment, the data mark 14 may comprise a passive electronic device, such as an RFID (Radio Frequency Identification) tag placed within the pack 12, with the tag being activated and read by a downstream RFID reader. It should be readily appreciated that the type and configuration of the data mark 14 may vary widely within the scope and spirit of the invention.

At the load station 18, the individual packs 12 are placed onto individual positions 22 defined on the conveyor 20 in a manual or automated process. In the illustrated embodiment, the conveyor positions 22 are defined by individual trays 24, with each tray 24 sized and configured to hold a single pack 12. The packs 12 are placed and oriented on the trays 24 so that the data marks 14 are properly oriented for scanning by an associated reader/scanner 48 disposed at an initial position along the conveyor 20. For example, the scanner 48 may be an optical scanner, such as a bar code reader, that is configured to scan bar code data marks 14 on a label applied to the packs 12, or individual bar codes applied to tickets within the pack 12. The scanner 48 may be an electronic scanner configured to retrieve information from a storage chip or other media within the pack. The individual packs 12 are placed onto the conveyor 20 in any random order and are scanned by the scanner 48 as they pass in a linear random sequence past the scanner 48.

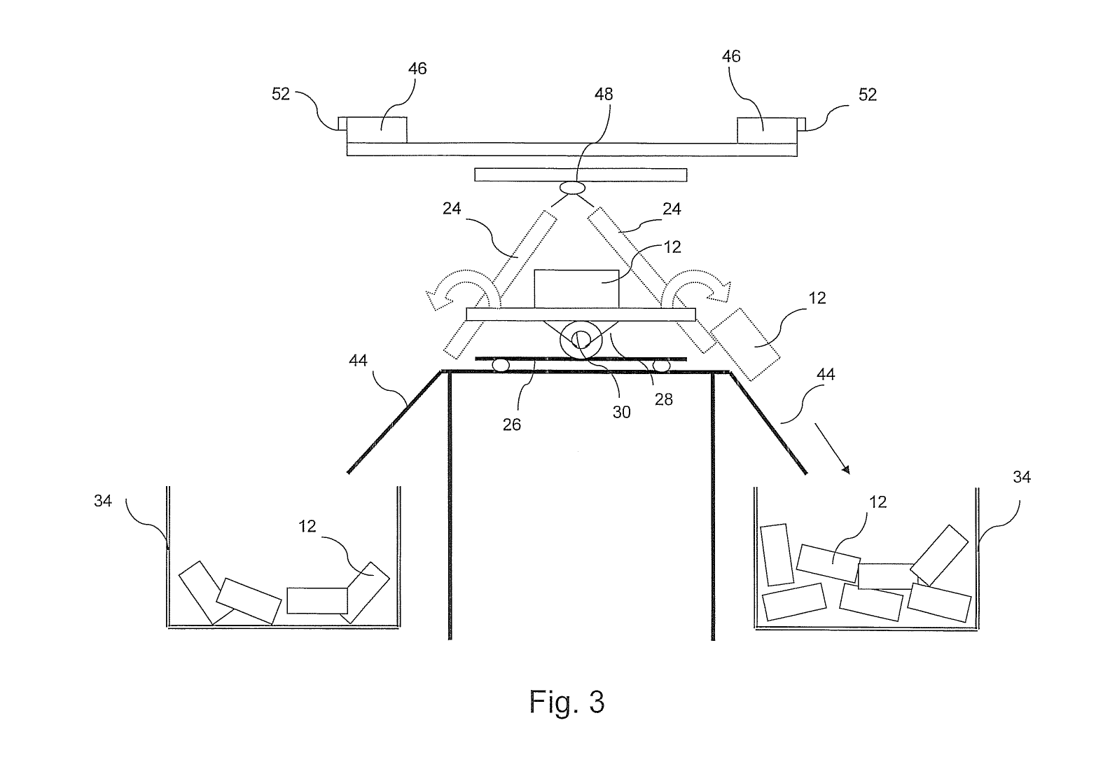

A plurality of bin positions 32 are defined along at least one longitudinal side of the conveyor 20, as illustrated in FIG. 1. In a desirable embodiment, bin positions are also defined along the opposite longitudinal side of the conveyor, for example as illustrated in the embodiment of FIG. 3. Each bin position 32 defines a unique deposit location for the ticket packs 12. At each bin position 32, a bin 34 is placed for receipt of the packs 12 that are deposited at each position. In the illustrated embodiment, the bins 34 are illustrated as simple open-ended containers. It should be readily appreciated that “bins” 34 are meant to represent any receptacle or receipt device for the packs 12, and may be, for example, individual conveyors, chutes, and so forth.

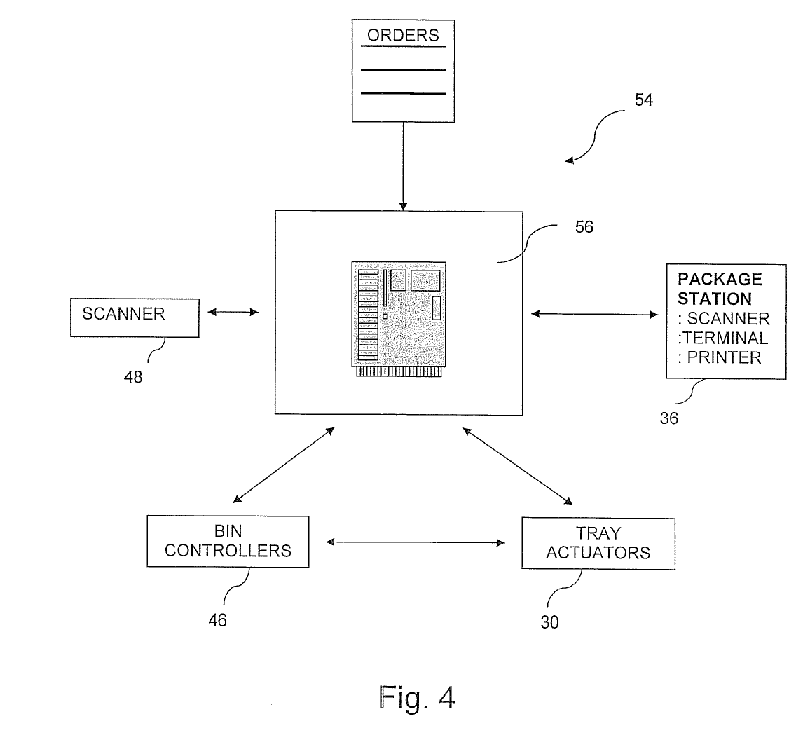

Referring to FIG. 4, a basic system component diagram is provided to illustrate concepts of a control system in accordance with aspects of the invention. For example, a control system 54 is illustrated that includes any manner of hardware/software implementation 56. The control system 54 synchronizes and controls the various operational aspects of the associated system components. For example, the computer system 56 may receive from another central control computer desired collections of the ticket packs 12. Alternatively, the computer system 56 may designate the collections from various data provided to the system. These collections may be, for example, shipments designated for a particular vendor. Each of the bin positions 32 (FIG. 1) are assigned one of these collections. For example, the system 10 may have a total of thirty bin positions 32, with each bin position 32 being assigned a unique collection of ticket packs as a function of the data marks 14 supplied on the individual packs 12.

The scanner 48 is in communication with the computer system 56, and as each pack 12 is scanned at the scanning station. The data mark 14 is read and the particular pack 12 is assigned to one of the downstream bin positions 32 where the pack 12 will be eventually deposited. It should be readily appreciated that any individual pack 12 could be associated with a plurality of the individual bin positions 32 depending on the particular requirements of the collection or order assigned to the bins 32. Also, because the packs 12 are received and placed on the conveyor 20 in random order, the control system 54 has the option to fill the bin requirements in any order. For example, a pack 12 initially passing by the scanner 48 may be identified as a type of pack needed in the first bin position 32, or the last bin position 32. The system 54 may designate the pack for either one of these bin positions, or any bin position in between. The system may distribute the packs 12 according to any desired fill sequence with respect to the bins 32.

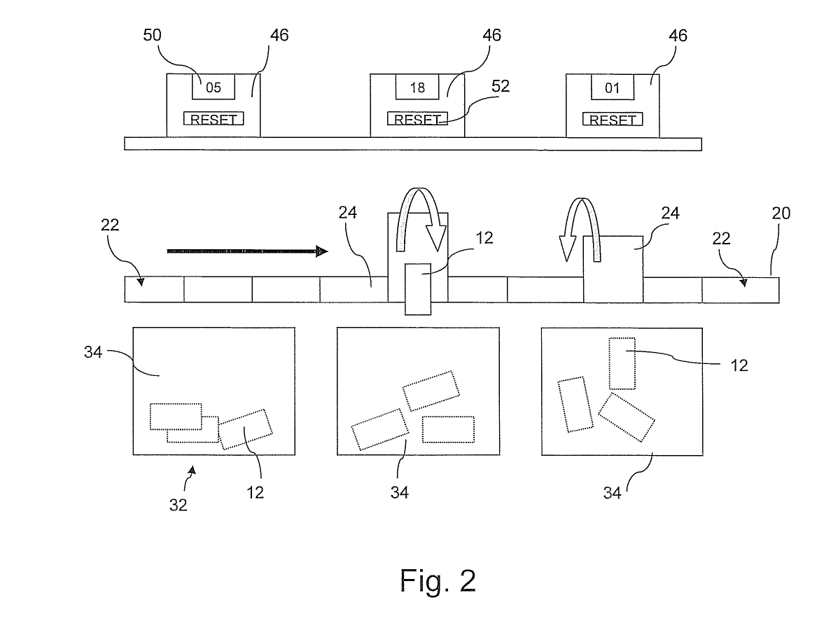

Referring to FIGS. 2 and 3, as the packs 12 are moved along the bin positions 32, means are provided for automatically moving or depositing the packs 12 from the individual conveyor positions 22 and into a bin container 34 associated with each bin position 32. This may be accomplished with any number of suitable devices. In the illustrated embodiment, as mentioned, each individual conveyor position 20 is associated with a tray 24. These trays 24 are configured to tilt in a transverse plane relative to the longitudinal axis of the conveyor 20 in order to deposit the packs 12 along a slide 44 and into a bin 34, as particularly illustrated in FIG. 3. In the embodiment wherein bin positions 32 are aligned along both longitudinal sides of the conveyor 20, the trays 24 are configured to tilt in either transverse direction, as illustrated in FIG. 3. The trays 24 include an actuator 30 associated with actuating arms 28 to initiate and control the tilting process. The trays 24 and associated components are supported by structure 26 that moves along the conveyor 20, and upon a tray 24 reaching a designated bin position 32, the tray actuator 30 is automatically actuated by the control system 54 (FIG. 4) and causes the tray 24 to tilt in the desired direction in order to deposit the pack 12 into the proper bin 34.

It should be readily appreciated that the tray actuators 30 may comprise any manner of mechanical actuating device, and can vary widely within the scope and spirit of the invention. For example, the actuator 30 may comprise a mechanical device, hydraulic device, pneumatic device, and so forth.

In alternate embodiments, the means for automatically removing the ticket packs 12 from the conveyor 20 may comprise a system or device operably disposed at each bin position. For example, an air jet bank may be disposed alongside the conveyor 20, with at least one air jet associated with each bin position 32. As the conveyor 12 moves a pack 12 past a bin position designated for that respective pack 12, the associated air jet is actuated to essentially blow the pack 12 off of the conveyor 20 and into the bin receptacle 34. In still alternate embodiments, a mechanical arm may be provided at each bin position to physically push the pack 12 off of the conveyor 20 and into a receptacle 34 at the bin position. It should thus be understood that the means for automatically removing the ticket packs from the conveyor encompasses any suitable system associated with individual trays 24 along the conveyor 20, or associated with each bin position.

Still referring to FIGS. 2 and 3, in the particular illustrated embodiment, bin position controllers 46 are provided at each bin location 32. These controllers 46 may contain any manner of hardware and software architecture to increase the functionality of the system at the individual bin positions 32. For example, the bin controllers 46 may be in communication with the control system 54 (FIG. 4) and may include a display, such as a control panel, screen, or the like, to indicate any information related to the unique collection or order assigned to each individual bin position 32. For example, a readout or printout may be provided at each of the controllers 46 to indicate the number of packs 12 to be received at that bin position, or any other information related to the collection or order. In the illustrated embodiment, each controller 46 includes a countdown display 50 that visually indicates to personnel the number of packs 12 to be deposited into the associated bin 34. For example, referring to FIG. 2, the middle bin controller 46 has a display 50 indicating the numeral “18.” This conveys to personnel that eighteen packs 12 are still needed to complete the collection or order associated with the bin position 32. As additional packs 12 are deposited at the bin position 32, the counter is automatically decremented so as to count down to “0.” Thus, once the collection or order is completed, the counter reads “0” and personnel are aware that the order is complete and that the bin 34 can be removed from the conveyor 20 for further processing.

Once a collection is complete at any individual bin position 32, the bin position can be “reset” and assigned another collection or order by the control system 54. The reset process may be initiated by a person simply depressing an actuator 52 at the control panel 46 after the filled bin 34 has been removed and a new bin 34 replaced at the bin position 32.

The control system 54 may assign new orders or collections to the bin position 32 in various ways. For example, in a particular control scheme, the control system 54 assigns the orders in a batch process wherein all of the bins are assigned new collections at the same time. In this batch process, the new collections would not be assigned until all of the previously assigned bin collections have been satisfied. In a serial process, the system may assign a new collection to any individual bin position 32 as soon as that bin position becomes available. For example, the system 54 may contain a queue of orders or collections whereby the next collection in the queue is automatically assigned to the next available bin position 32. In this scheme, each of the bin positions 32 will always have a collection assigned thereto.

Referring to FIGS. 1 and 4 in particular, once the individual bins 34 have been removed from alongside the conveyor 20 upon completion of the collection assigned to the respective bin position 32, the completed collection may be moved to another station for further processing. In the illustrated embodiment, the bins 34 are moved to a packaging station 36 where they may be verified and packaged for shipment to particular vendors. The package station 36 may include any manner of control equipment to verify the integrity and correctness of the order. For example, a scanner 38 may be provided at the station 36 to scan any one of the articles 12 within an individual bin 34 brought to the station. This event triggers the control system 54 via computer 40 to generate a printout or visual indication as to the order or collection within the bin 34. For example, this indication may tell an inspector at the station 36 the exact type and number of articles 12 that should be in the bin. The inspector may then verify that the correct packs 12 are actually contained in the bin, and then package the packs into a package 42 for shipment.

It should be readily appreciated that any manner of further processing may be conducted with the bins 34 and completed collections of packs 12. For example, the entire system and associated methodology may be a component of an inventory control system wherein the collections of packs 12 are sent to a storage location or other facility.

The methodology of the system 10 according to the invention may be accomplished with any manner of conventionally available components, including conveyors, control systems, and so forth. For example, a suitable tray-type conveyor wherein individual positions are defined along a conveyor by trays that tilt in either direction, as described above, is available from GBI Data and Sorting Systems of Deerfield Beach, Fla., and as identified as “Tilt-Tray” model. Those skilled in the art may readily configure any manner of commercially available processing and sorting machinery in accordance with the present invention.

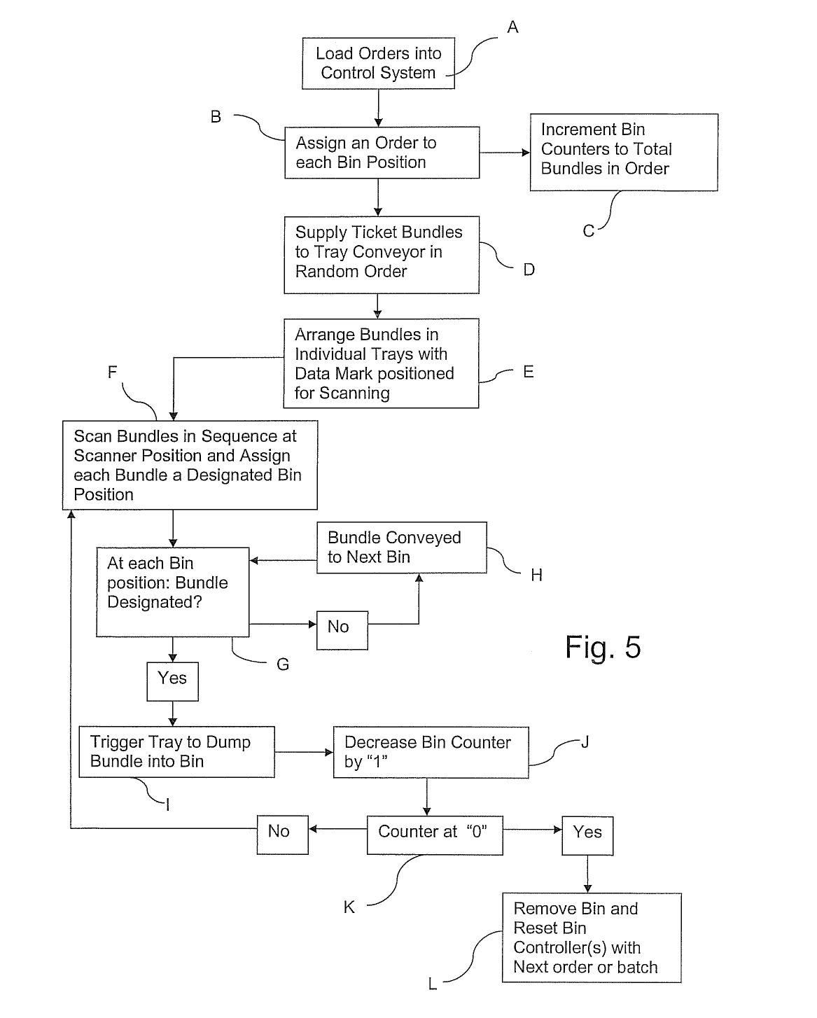

FIG. 5 illustrates a basic flow chart diagram of an embodiment of the system and method according to the invention for sorting random packs of lottery tickets according to particular shipments/orders. In step A, the orders are loaded into a central control system, and in step B individual orders are assigned to respective bin positions along a sorting conveyor. At step C, at each bin position, a display counter is incremented to reflect the total packs in the order that are assigned to that respective bin position. In step D, a random mix of the ticket packs are supplied to the sorting conveyor, in particular a tray conveyor. In step E, the packs are arranged in individual trays on the conveyor so that a data mark associated with each pack is in a proper position for subsequent scanning. The data mark includes any manner of configuration necessary to associate an individual pack with a respective order.

In step F, the packs are scanned in sequence at one or more scanner positions and are then conveyed in the scanned sequence to the respective bin positions. Based on the information received by the control system in the scanning process, each individual ticket pack is designated for deposition at a particular bin position as a function of the fill sequence implemented by the control system. As the packs are conveyed to each bin position in step G, if the particular pack is designated for that bin, the control system triggers the tray actuator to dump the pack into the bin at step 1. If the pack is not designated for that particular bin, then the pack is conveyed to the next bin in step H. When the pack is dumped into a particular bin, the counter at that bin is decreased by “1” in step J. If the counter is not at “0” in step K, then the particular order associated with that bin position is not filled and the bin remains in the filling sequence. If the counter does indicate “0”, then the order associated with that particular bin has been filled and the bin is removed at step L. The bin controller may be reset upon receipt of a new order. As discussed, these orders may be assigned in a batch sequence wherein all bins receive new orders at once, or in a serial sequence wherein individual bins receive orders as they become available.

It should be appreciated by those skilled in the art that various modifications and variations can be made to the systems and methods described herein without departing from the scope and spirit of the invention. For example, in the illustrated embodiment, a single scanner is used at a single position relative to the conveying line to scan the ticket packs as they are conveyed therepast. In an alternate embodiment, individual scanners may be placed at each of the bin positions such that the packs are individually scanned at each position to determine if that pack belongs to the collection associated with the bin position. In this particular embodiment, the control system could assign the collections to each of the individual bin controllers, wherein the bin controllers would then determine whether the pack being scanned at the respective bin controller is an item needed to fill the respective collection. Other modifications and variations to the system are also possible.

What is claimed is:

1. An automated method for sorting packs of lottery tickets supplied in a random order, each ticket pack having a data mark, said method comprising:
designating collections of the ticket packs, and assigning each particular collection to a bin position along an automated sorting line, each ticket pack being identified with a particular collection as a function of the data marks on the ticket packs;
conveying the ticket packs in a random linear sequence past a data mark reader and to the bin positions;
for each scanned pack, determining the bin position for a collection the respective ticket pack is needed for;
automatically removing the ticket packs needed for the collection at each individual bin position from the conveyed random sequence of ticket packs; and
upon satisfying the collection requirements at any individual bin position, removing the completed collection for further processing of the collection, and assigning a new collection to the bin position.

2. The method as in claim 1, comprising optically scanning the data marks at an initial position along the sorting line.

3. The method as in claim 1, wherein the collections of ticket packs correspond to different lottery ticket shipments related to a respective customer orders, said further processing of the collections comprising verifying and shipping the shipments.

4. The method as in claim 3, wherein the data marks on each ticket pack are unique to a particular shipment number and are compared to the shipment assigned to the respective bin positions to determine at which bin position a particular ticket pack is to be removed from the sorting line.

5. The method as in claim 3, wherein the data marks on each ticket pack identify a characteristic of the lottery tickets in the pack that is compared to requirements of the collections assigned to the respective bin positions.

6. The method as in claim 1, wherein a new collection is assigned to all of the bin positions in a batch.

7. The method as in claim 1, wherein a new collection is assigned to individual bin positions in a serial process.

8. The method as in claim 1, wherein the ticket packs are conveyed at individual positions on a linear conveyor past the bin positions, the individual positions being automatically actuated to move the ticket packs off of the conveyor and into a bin at the proper bin position.

9. The method as in claim 1, further comprising visibly indicating at each of the bin positions the total required number of ticket packs required to complete the collection assigned to the respective bin position, and decrementing the indication each time a ticket pack is removed from the conveyed line of ticket packs at the bin positions.

10. The method as in claim 9, wherein a completed collection is removed from a respective bin position when the number indication reaches “0.”

11. The method as in claim 10, further comprising resetting the number indication at the respective bin position upon assigning a new collection to the bin position.

12. An automated system for sorting packs of lottery tickets supplied in a random order, each ticket pack having a data mark, said system comprising:
a ticket pack conveyor having a plurality of individual positions defined therealong for receipt of an individual ticket pack at each said conveyor position;
a plurality of bin positions defined alongside at least one longitudinal side of said conveyor;
a reader operatively associated with said conveyor to read the data marks on each ticket pack conveyed past said reader;
means for automatically removing a ticket pack from said conveyor positions and into a bin at said bin positions; and
a control system in communication with said reader and said removing means, said control system assigning a collection of ticket packs to each of said bin positions and assigning a bin position to the ticket packs scanned on said conveyor as a function of the requirements of the collections, said control system automatically actuating said removing means upon the ticket packs being conveyed past their assigned bin positions to move the ticket packs into their assigned bins.

13. The system as in claim 12, wherein said conveyor positions on said conveyor are defined by individual trays, said trays being pivotally mounted on said conveyor and said removing means comprising a mechanical actuator configured to automatically tilt said trays at said bin positions.

14. The system as in claim 13, further comprising a plurality of bin positions defined along both longitudinal sides of said conveyor, said trays being pivotally mounted so as to tilt in either transverse direction relative to said conveyor.

15. The system as in claim 12, wherein said reader comprises an optical scanner provided at an initial position along said conveyor.

16. The system as in claim 12, further comprising a removable and replaceable bin placed at each of said bin positions.

17. The system as in claim 12, further comprising a control panel associated with each of said bin positions, said control panel comprising a display that indicates the number of ticket packs required to complete a collection assigned to the respective said bin position.

18. The system as in claim 17, wherein said displays are automatically decremented each time a ticket pack is removed at said respective bin positions.

19. The system as in claim 17, wherein said displays are in communication with said control system and are reset by said control system upon a new collection being assigned by said control system to said bin positions.

20. The system as in claim 12, wherein upon completion of a collection at a respective bin position, said control system is configured to automatically assign a new collection of ticket packs to said respective bin position.
